(19) United States
(12) Patent Application Publication
(10) Pub. No.: US 2009/0127047 A1
(43) Pub. Date: May 21, 2009

(54) Cable Drum

(75) Inventors: Uwe Simon, Markkleeberg (DE); Frank-Michael Hirsch, Beucha (DE); Martin Baer, Monheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Komatsu Mining Germany GmbH, Duesseldorf (DE)

(21) Appl. No.: 12/084,160

(22) PCT Filed: Oct. 19, 2006
(86) PCT No.: PCT/DE2006/001865

§ 371 Date: Jun. 12, 2008

(30) Foreign Application Priority Data
Oct. 28, 2005 (DE) 10 2005 052 283.1

(51) Int. Cl. H02G 11/02

(52) U.S. Cl. 191/12.2 R

(57) ABSTRACT

Apparatus for supplying electrical energy to a mobile working machine in the off-road sector, wherein a supporting arm is provided on the working machine, and a drum for accommodating a cable is mounted on the supporting arm. A slip ring body is arranged in the interior of the drum shell, the slip ring body having a plurality of individual slip rings, from which the electrical energy is taken via brushes and transmitted to a cable which is passed on into the working machine. The slip ring body is mounted so that it is separated mechanically from the drum casing on a common axis, and means are provided for transferring the revolution of the drum casing to the inner slip ring body.

The invention pertains to a cable drum for supplying electrical energy to a mobile working machine in the off-road area.

In large mobile working machines which run on electricity, this energy must be delivered through a cable. Batteries are usually not suitable for long-term use at high power requirements. The cables are adapted specifically to the harsh operating conditions present at construction sites or mining operations and are usually held on a drum mounted at the rear of the vehicle. Depending on the requirements, spooling and/or routing devices are used to ensure that the cable can be wound and paid-out neatly.

In hydraulic excavators for surface mining, however, the available designs are not adequate. These machines are able to maneuver even on the most difficult terrain. The machine comes into repeated contact with the material which it has pushed into piles, with individual boulders, and even with small airborne rocks. Under these conditions, cable drums of the conventional designs fail after a short time.

The task of the present invention is to present an improved cable drum for use on a mobile working machine which can withstand the extremely harsh working conditions to which hydraulic excavators are subjected in surface mining operations. In addition, it should be possible to repair quickly and easily the parts on or in the cable drum which can be easily damaged.

This task is accomplished according to the invention by a cable drum for supplying electricity to a mobile working machine in the off-road area, where

a supporting arm, on which a drum for holding the cable is mounted, is provided on the working machine;

inside the drum shell, a slip ring body is installed, which consists of several individual slip rings, from which the electrical energy is collected with brushes and transmitted to a cable leading onward to the working machine;

the slip ring body is supported on the same axis as the drum shell but is mechanically separated from the shell; and

means are provided to transmit the rotation of the drum shell to the inner slip ring body.

It is advantageous for a spooling and routing system to be mounted on the supporting arm to guide the cable in such a way that it can be laid in an orderly manner, layer by layer, on the drum shell and so that a cable lying on the ground can be laid down on the ground and picked up without excessive mechanical stress.

The rotation of the drum shell can be transmitted to the slip ring body by a driver pin.

According to an elaboration of the invention, the supporting arm is protected from damage from below by a grill.

A device is provided inside the drum shell to remove moisture from the empty space inside the drum. Its task will be described in greater detail below.

Finally, according to another elaboration, equipment is provided under the grill, i.e., on the side of the supporting arm facing the ground, for monitoring the distance between the supporting arm and the ground.

The invention is explained in greater detail below on the basis of an exemplary embodiment:

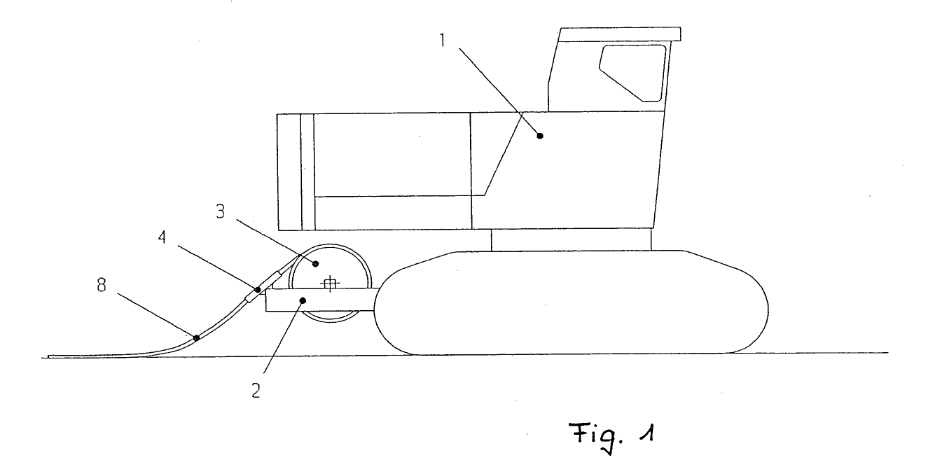

FIG. 1 shows a schematic diagram of the working machine;

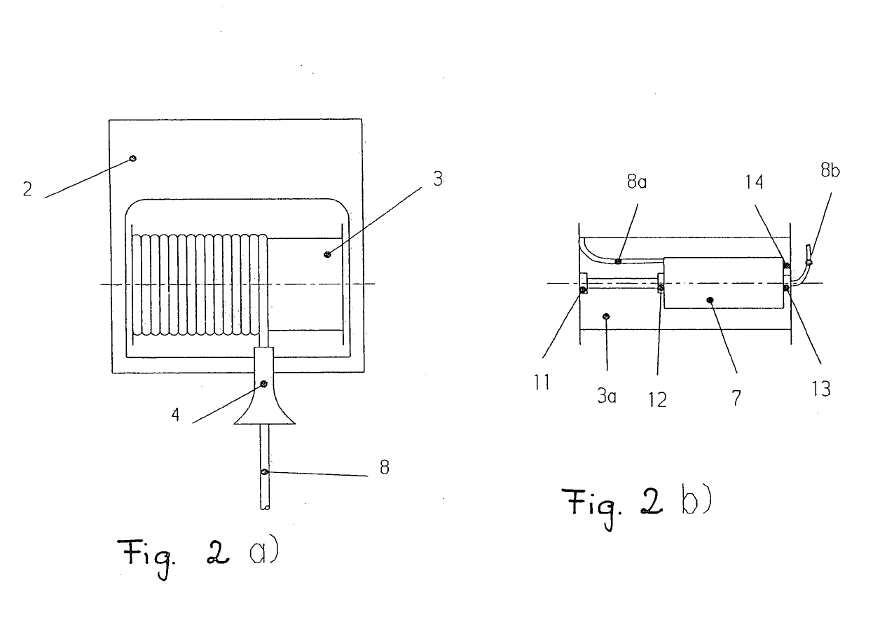

FIGS. 2a and 2b show details of the cable drum in simplified form; and

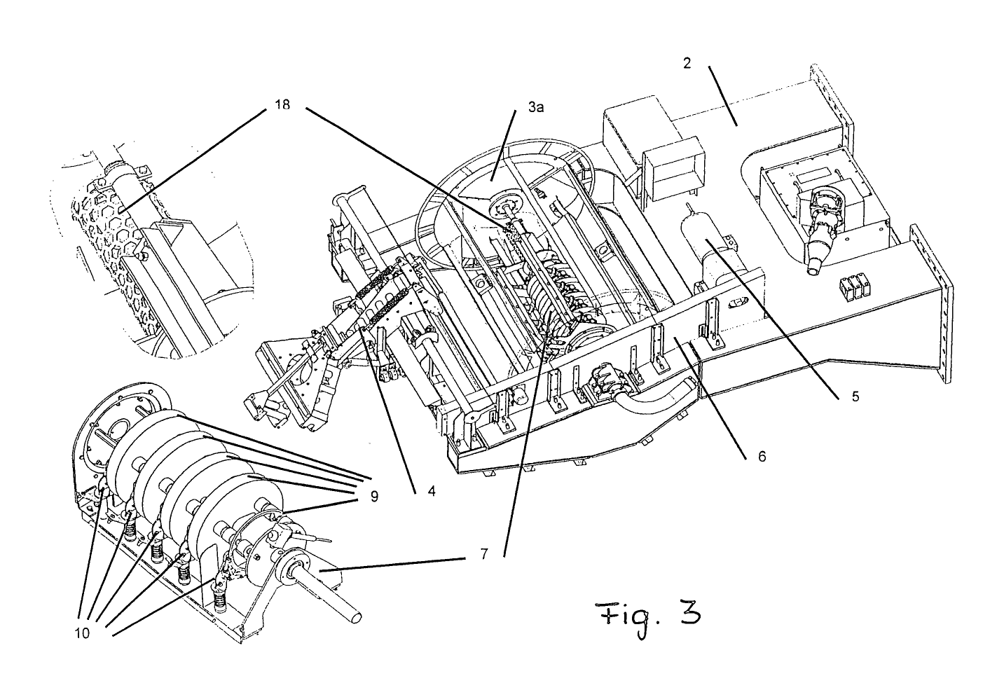

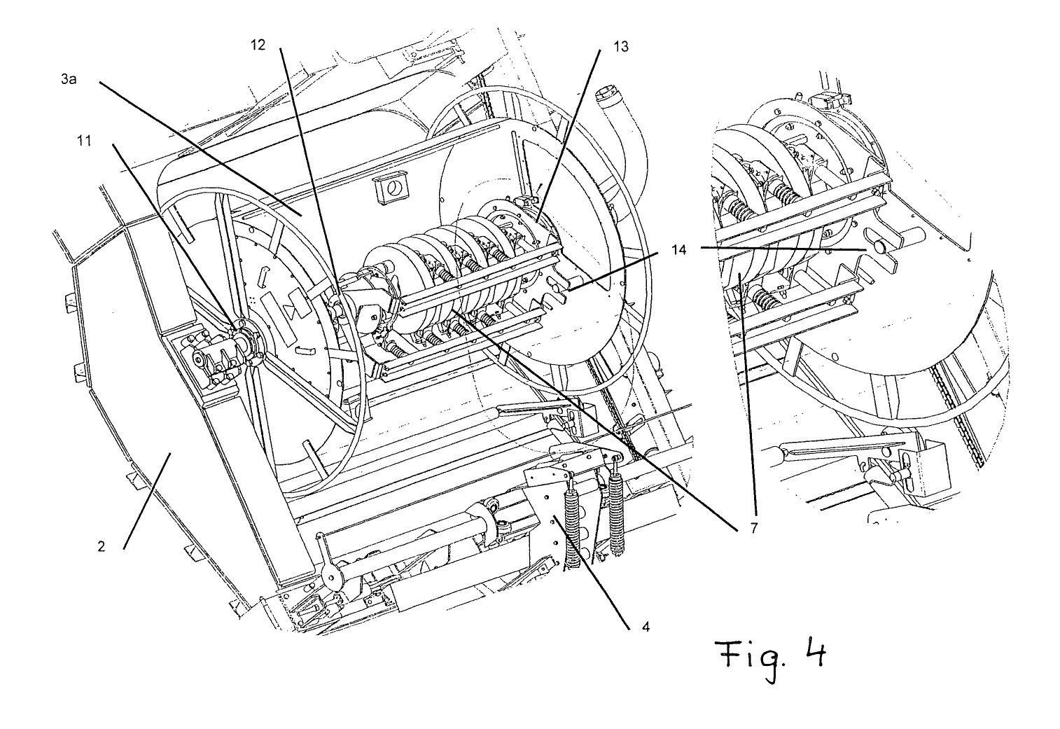

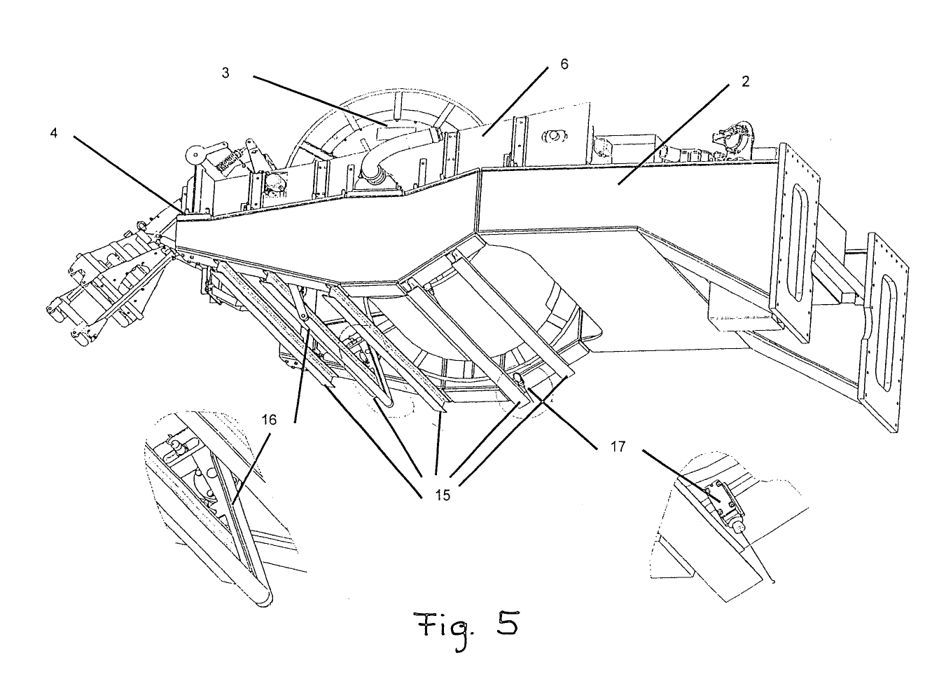

FIGS. 3-5 show perspective views of the cable drum and its mounting on the supporting arm.

At the rear of the crawler undercarriage of a hydraulic excavator 1, a supporting arm 2 is provided, on which a drum 3 for holding a cable 8 is mounted. The supporting arm is attached to the solid central part between the mobile crawlers in such a way that it does not interfere with the travelling movements of the vehicle. The supporting arm itself also offers the base for a spooling and routing system 4. This spooling and routing system has the function of routing the cable so that it is laid in orderly fashion, layer by layer, on the drum shell. It also has the job of ensuring that the cable lying on the ground can be laid on the ground and picked up without excessive mechanical stress.

The cable 8a is guided from the shell of the cable drum 3 onward into the interior 3a, where it delivers the electrical energy through an inner slip ring body 7. This inner slip ring body consists of several individual slip rings 9, from which the electrical energy is collected with brushes 10 and delivered to another cable 8b leading onward. For each individual wire of the cable there is a pair of transfer components, each pair consisting of a slip ring and one or more brushes. The slip ring represents the stationary part, whereas the brushes are mounted on a frame, which represents the horizontally rotating part. This inner part requires a minimum accuracy of the positioning between the slip rings and the brushes.

To ensure the accuracy of the positioning of the slip ring body even under the action of external forces on the drum shell or its deformation resulting from such forces, the inner slip ring body 7 is completely separated mechanically from the drum shell except for the bearings 12, 13. The drum shell has its own bearings 11, 13 and transmits the rotation of the shell to the inner slip ring body by means of a driver pin 14. The bearing 13 consists of two bearings, one for the inner slip ring body and another for the drum shell.

To prevent damage from underneath, the supporting arm 2 is also reinforced from below by a sturdy grill of cross-struts 15 under the opening of the cable drum. Individual rocks or small piles of material can thus be pushed aside as the excavator moves without damaging the cable drum. The structure continues to remain open, so that material intruding from above such as earth or stones will not be captured. No danger to the spooling and routing system is to be expected from material coming up from below, because in that case the spooling and routing system is automatically raised by the cable.

Monitoring equipment 16, 17 for detecting ground collisions is also provided under the grill 15, which can push aside individual rocks or small piles of material. This detection is carried out by means of two different types of switches.

Collisions toward the rear and the bottom are detected by a “bail” 16, which is mounted with freedom of horizontal rotation so that it is lifted upward and toward the front when it makes contact with any material. It can move completely into the intermediate spaces of the grill, which minimizes damage in the event of a collision. The rotation of the “bail” is detected by suitable stop switches inside the protected area of the supporting arm.

Ground contact is much less common toward the front. Therefore, simple stop switches 17 with long rods are used here. The rod actuates the switch directly upon contact with material. These switches are also located inside the area of the supporting arm 2 protected by the grill 2.

The ground collision monitoring equipment transmits signals, which initiate further actions such as the sounding of an alarm or deactivation of a travelling movement.

When electricity is transmitted by means of slip rings and brushes, the parts of the system are subject to adhesive wear and must be replaced at regular intervals. In a climate with high humidity and wide temperature fluctuations, the need to open the cable drum to replace worn-out components can lead to the formation of considerable amounts of condensate inside the drum chamber. This can lead to corrosion and also, when high voltages are being transmitted, to electrical flash-overs, which can destroy all the inner workings of the cable drum. The inside 3a of the cable drum is therefore equipped with a container 18 which can hold an agent for dehumidifying the air. The absorption capacity of the dehumidifying agent is determined so that even completely moisture-saturated air can be dried the extent that it is impossible for condensate to form even when the widest temperature difference to be expected occurs. The dehumidifying agent is introduced as the last step before the drum is closed. Moisture can also be removed by some other means such as by the use of an air-conditioning system with external condensate drainage.

1.-6. (canceled)

7. Apparatus for supplying electrical energy to a mobile working machine, the apparatus comprising:
a supporting arm which can be fixed to the working machine;
a cable drum mounted on the support arm, the cable drum comprising a drum shell on which a supply cable can be wound, the drum shell being rotatable about an axis of rotation;
a slip ring body having individual slip rings inside the drum shell, the slip ring body being supported for rotation about the axis of rotation and being mechanically separate from the drum shell;
a plurality of brushes which collect electrical energy from the slip rings and transfer said energy to an onboard cable leading to the working machine; and
means for transmitting rotation of the drum shell to the slip ring body.

8. The apparatus of claim 7 further comprising a winding and guide system mounted on the supporting arm for guiding the supply cable so that it is wound on the drum shell in layers, and so that the supply cable can easily be laid on the ground and picked up.

9. The apparatus of claim 7 wherein the means for transmitting rotation of the drum shell to the slip ring body comprises a drive pin.

10. The apparatus of claim 7 further comprising a grill fixed to the supporting arm to protect the drum from damage from below the grill.

11. The apparatus of claim 7 wherein the drum defines an enclosed space, the apparatus further comprising means for dehumidifying the enclosed space.

12. The apparatus of claim 7 further comprising means mounted on the support arm for monitoring the distance between the support arm and the ground.
